(19) United States
(12) Patent Application Publication
(10) Pub. No.: US 2026/0289766 A1
(43) Pub. Date: Sep. 24, 2026

(54) SYSTEMS, APPARATUSES, AND METHODS FOR DETERMINING AN IMAGING APPROACH

(71) Applicant: Siemens Healthineers AG, Forchheim (DE)

(72) Inventors: Gregor Körzdörfer, Marburg (DE); Mathias Nittka, Baiersdorf (DE); Venkata Veerendranadh Chebrolu, Rochester, MN (US)

(21) Appl. No.: 19/083,710

(22) Filed: Mar. 19, 2025

(51) Int. Cl. G06T 7/00; G01J 3/28; G06T 7/11

(52) U.S. Cl. CPC G06T 7/0012; G01J 3/28; G06T 7/11; G06T 2207/20081

(57) ABSTRACT

A system for determining an imaging approach includes at least one memory configured to store instructions and at least one processor configured to execute the instructions to cause the system to apply a plurality of radio frequency (RF) pulses to a region of interest to acquire spectral information, each pulse having a different center frequency, process the spectral information to output a spectrum for the region of interest, and determine the imaging approach based on the spectrum for the region of interest.

### TECHNICAL FIELD

The present disclosure relates to systems, apparatuses, and/or methods for determining an imaging approach.

### BACKGROUND

Magnetic field distortion levels are known to impact image quality in medical imaging. Magnetic field distortion may be caused by metal implants and may be unique to each patient.

### SUMMARY

At least one example embodiment relates to a system for determining an imaging approach, the system may include at least one memory configured to store instructions and at least one processor configured to execute the instructions to cause the system to apply a plurality of radio frequency (RF) pulses to a region of interest to acquire spectral information, each pulse having a different center frequency, process the spectral information to output a spectrum for the region of interest, and determine the imaging approach based on the spectrum for the region of interest.

In at least one example embodiment, the different center frequencies of the RF pulses may be between about −10 kHz to 10 kHz.

In at least one example embodiment, processing the spectral information may include determining a cumulative RF profile by determining an excitation RF profile for each pulse of the plurality of RF pulses and adding excitation RF profiles that include corresponding center frequency shifts to obtain the cumulative RF profile.

In at least one example embodiment, the at least one processor may be further configured to cause the system to threshold the spectrum from the region of interest by removing spectral content below a threshold level to obtain a thresholded spectrum and divide the thresholded spectrum with the cumulative RF profile to obtain a normalized spectrum. In at least one example embodiment, the at least one processor may be further configured to cause the system to segment the spectrum into one or more segments. In at least one example embodiment, the imaging approach may be determined by comparing the spectrum for the region of interest to one or more thresholds. In at least one example embodiment, a level of inhomogeneity of the spectrum may be determined from the one or more thresholds. In at least one example embodiment, the one or more thresholds may include a first threshold corresponding to a first level of inhomogeneity, a second threshold corresponding to a second level of inhomogeneity, a third threshold corresponding to a third level of inhomogeneity, a first imaging approach may correspond to the first level of inhomogeneity, a second imaging approach may correspond to the second level of inhomogeneity, and a third imaging approach may correspond to the third level of inhomogeneity. In at least one example embodiment, a deep learning approach may be used to compare the spectrum for the region of interest to the one or more thresholds to determine the imaging approach. In at least one example embodiment, the at least one processor may be further configured to cause the system to determine a percentage value histogram from the normalized spectrum for each of the one or more segments. In at least one example embodiment, the at least one processor may be further configured to cause the system to determine a first plurality of segments of the one or more segments that include a threshold amount of the normalized spectrum. In at least one example embodiment, the at least one processor may be further configured to cause the system to perform imaging using the imaging approach by exciting the region of interest one or more times with an excitation pulse corresponding to the first plurality of segments.

In at least one example embodiment, the imaging approach may be determined by comparing the spectrum to stored spectra.

Also described herein is a prescan method for determining an imaging approach. The method may include applying a plurality of radio frequency (RF) pulses to a region of interest to acquire spectral information, each pulse having a different center frequency, processing the spectral information to output a spectrum for the region of interest, and determining the imaging approach based on the spectrum for the region of interest.

In at least one example embodiment, the different center frequencies of the RF pulses may be between about −10 kHz to 10 kHz.

In at least one example embodiment, the processing the spectral information may include determining a cumulative RF profile by determining an excitation RF profile for each pulse of the plurality of RF pulses and adding excitation RF profiles that include corresponding center frequency shifts to obtain the cumulative RF profile. In at least one example embodiment, the method may further include thresholding the spectrum from the region of interest by removing spectral content below a threshold level to obtain a thresholded spectrum and dividing the spectrum with the cumulative RF profile to obtain a normalized spectrum. In at least one example embodiment, the imaging approach may be determined by comparing the normalized spectrum for the region of interest to one or more thresholds. In at least one example embodiment, a level of inhomogeneity of the spectrum may be determined from the one or more thresholds. In at least one example embodiment, the one or more thresholds may include a first threshold corresponding to a first level of inhomogeneity, a second threshold corresponding to a second level of inhomogeneity, a third threshold corresponding to a third level of inhomogeneity, a first imaging approach may correspond to the first level of inhomogeneity, a second imaging approach may correspond to the second level of inhomogeneity, and a third imaging approach may correspond to the third level of inhomogeneity. In at least one example embodiment, a deep learning approach may be used to compare the spectrum for the region of interest to the one or more thresholds to determine the imaging approach. In at least one example embodiment, the method may further include segmenting the normalized spectrum into one or more segments, determining a first plurality of segments of the one or more segments that include a threshold amount of the spectrum, and performing imaging using the imaging approach by exciting the region of interest one or more times with an excitation pulse corresponding to the first plurality of segments.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A is an illustration of a system for implementing methods according to example embodiments.

FIG. 1B is a block diagram illustrating an example embodiment of the system shown in FIG. 1A.

FIG. 2 illustrates a prescan method for determining an imaging approach in accordance with at least one example embodiment.

FIG. 3 illustrates a step of processing spectral information of the prescan method of FIG. 2 in accordance with at least one example embodiment.

FIG. 4 illustrates a step of determining an imaging approach of the prescan method of FIG. 2 in accordance with at least one example embodiment.

FIG. 5 illustrates a comparison between a normalized metal off resonance signal and a normalized no metal off resonance signal in accordance with at least one example embodiment.

### DETAILED DESCRIPTION OF EXAMPLE EMBODIMENTS

Independent of the grammatical term usage, individuals with male, female or other gender identities are included within the term.

Some detailed example embodiments are disclosed herein. However, specific structural and functional details disclosed herein are merely representative for purposes of describing some example embodiments. Example embodiments may, however, be embodied in many alternate forms and should not be construed as limited to only example embodiments set forth herein.

Accordingly, while example embodiments are capable of various modifications and alternative forms, example embodiments thereof are shown by way of example in the drawings and will herein be described in detail. It should be understood, however, that there is no intent to limit an example embodiment to the particular forms disclosed, but to the contrary, example embodiments are to cover all modifications, combinations, equivalents, and alternatives falling within the scope of an example embodiment. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiment.

The terminology used herein is for the purpose of describing various example embodiment only and is not intended to be limiting of example embodiment. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements and/or groups thereof.

When the words “about” and “substantially” are used in this specification in connection with a numerical value, it is intended that the associated numerical value include a tolerance of ±10% around the stated numerical value, unless otherwise explicitly defined. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiment belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Metallic implants in patients may lead to off-resonances that can cause magnetic resonance (“MR”) imaging artifacts and/or distortions. Several MR imaging techniques are available to mitigate artifacts and distortion. However, the ideal imaging technique for a particular patient is generally unknown before a localizer scan is performed. Further, even with the localizer scan, it is difficult to determine an optimal imaging technique for a particular patient. Thus, many MR imaging operators determine an MR imaging technique based on individual experience. The systems and methods described herein provide improved methods for determining an MR imaging approach. In particular, the systems and methods described herein provide a prescan method that is quick and may provide objective guidance for what scan strategy to use for a patient with a metallic implant. For example, the prescan method may be completed in a matter of seconds which may provide important information to an operator without adding a significant amount of time to an imaging method.

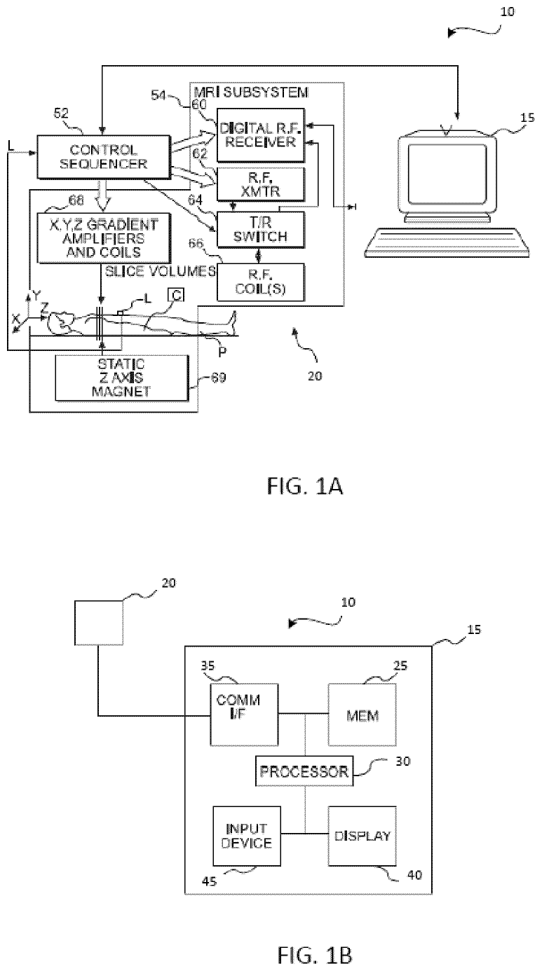

FIG. 1A is an illustration of a system for implementing methods according to example embodiments described herein. FIG. 1B is a block diagram illustrating an example embodiment of the system shown in FIG. 1A. Although one or more example embodiments may be described herein with regard to the systems shown in FIGS. 1A and 1B, example embodiments should not be limited to these examples.

Referring to FIGS. 1A and 1B, a system 10 may include an information processing device 15 and an acquisition device 20. The acquisition device 20 includes an MRI real-time control sequencer 52 and an MRI subsystem 54. The MRI subsystem 54 may include XYZ magnetic gradient coils and associated amplifiers 68, a static Z-axis magnet 69, a digital radiofrequency (“RF”) transmitter 62, a digital RF receiver 60, a transmit/receive switch 64, and RF coil(s) 66. The acquisition device 20 may include additional or fewer components in some example embodiments, and may be configured to image a patient.

The MRI subsystem 54 may be controlled in real-time by the MRI real-time control sequencer 52 to generate and measure magnetic field and radio frequency emissions that stimulate nuclear magnetic resonance (“NMR”) phenomena in an object P (e.g., a human or other living body) to be imaged.

The information processing device 15 may implement a method for processing medical data, such as medical image data. As discussed in more detail below, one or more information processing devices such as the information processing device 15 may be configured to implement any or all of the example embodiments described herein.

In FIGS. 1A and 1B, the acquisition device 20 is shown as a separate unit from the information processing device 15. It is, however, possible to integrate the information processing device 15 as part of the acquisition device 20.

The information processing device 15 may include at least one memory 25, processing circuitry including at least one processor 30, at least one communication interface 35 and/or an input device 40. The at least one memory 25 may include various special purpose program code including computer executable instructions which may cause the at least one processor 30 of the information processing device 15 to perform one or more of the methods according to example embodiments described herein. The acquisition device 20 may provide the medical data to the information processing device 15 via the input device 40. In some example embodiments, the information processing device 15 may additionally include a display 45 that may be configured to output information about one or more of an imaging process, the information processing device 15, or the acquisition device 20.

As will be appreciated, depending on the implementation of the system 10, the system 10 may include additional components. However, it is not necessary that all of these generally conventional components be shown in order to disclose the illustrative example embodiment. For example purposes, the system 10 will be discussed with regard to the at least one processor 30. However, it should be understood that the system 10 may include one or more processors or other processing circuitry, such as one or more Application Specific Integrated Circuits (ASICs).

The at least one processor 30 may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, application-specific integrated circuit (ASIC), a neural network processing unit (NPU), an Electronic Control Unit (ECU), a quantum computer, and the like. In some example embodiments, the processing circuitry may include a non-transitory computer readable storage medium or device (e.g., memory), for example a solid state drive (SSD), storing a program of instructions, and a processor (e.g., CPU) configured to execute the program of instructions to implement the functionality and/or methods performed by some or all of the systems according to any of the example embodiments.

The at least one memory 25 may be a computer readable storage medium that generally includes a random access memory (RAM), read only memory (ROM), and/or a permanent mass storage device, such as a disk drive. The at least one memory 25 may also store an operating system and any other routines/modules/applications for providing the functionalities of the system 10 to be executed by the at least one processor 30. These software components may also be loaded from a separate computer readable storage medium into the at least one using a drive mechanism (not shown). Such separate computer readable storage medium may include a disc, tape, DVD/CD-ROM drive, memory card, or other like computer readable storage medium (not shown). In some example embodiments, software components may be loaded into the at least one memory 25 via one of the at least one communication interface 35, rather than via a computer readable storage medium.

The at least one processor 30 or other processing circuitry may be configured to carry out instructions of a computer program by performing the arithmetical, logical, and input/output operations of the system. Instructions may be provided to the at least one processor 30 by the at least one memory 25.

The at least one communication interface 35 may be wired and may include components that interface the at least one processor 30 with the other input/output components. As will be understood, the at least one communication interface 35 and programs stored in the at least one memory 25 to set forth the special purpose functionalities of the system 10 will vary depending on the implementation of the system 10.

The at least one communication interface 35 may also include one or more user input devices (e.g., a keyboard, a keypad, a mouse, or the like) and user output devices (e.g., a display, a speaker, or the like).

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store a computer program or computer program code, and the at least one memory and the computer program code may be configured to, with at least one processor, the methods described herein. Additionally, the processor, memory and example algorithms, encoded as computer program code, serve as means for providing or causing performance of operations discussed herein. At least one other example embodiment may include a computer program including program segments or instructions that, when executed by at least one processor of a system, cause the system to perform the functions and methods described herein.

A code segment of a computer program may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

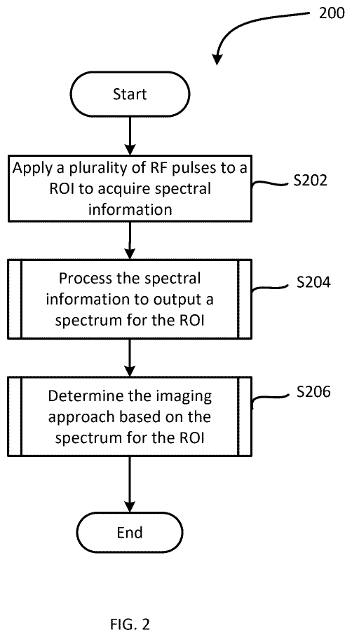

FIG. 2 is a flow chart of a prescan method 200 for determining an imaging approach. The prescan method 200 is described herein with respect to the system 10 described in FIGS. 1A and 1B above. The prescan method 200 may be configured to detect a presence of a field inhomogeneity in a field of view or a region of interest (ROI) and also may be configured to determine a degree of field distortion caused by a metallic implant. The prescan method 200 may take several seconds to complete so it may be fast and may be added to an examination without a significant increase in time. The prescan method 200 may be used or may use data acquired during a prescan to determine appropriate scan parameters for an imaging approach for the particular patient. The scan parameters and particular imaging approach may be optimized for a particular degree of field distortion and may provide optimal spectral coverage for imaging a ROI.

The prescan method 200 may begin at S202 where the at least one processor 30 applies a plurality of RF pulses to a ROI to acquire spectral information. In at least one example embodiment, each pulse of the plurality of RF pulses may have a different center frequency. In at least one example embodiment, each RF pulse may have a center frequency in a range from about −10 kHz to 10 kHz. The acquisition of the spectral information may be non-selective such that there is no gradient on during the application of the RF pulses and during a signal readout of the RF pulses to obtain a spectrum for each center frequency. In at least one example embodiment, the spectral information may only include one sample. For example, rather than obtaining samples for each voxel of an image, only the center of k-space may be obtained which results in a single sample of spectral information. Thus, only a center of k-space may be used to obtain an intensity per center frequency of the RF pulse. In at least one example embodiment, samples from the center of k-space may be obtained without a remainder of spectral data because intensities are being compared to determine an inhomogeneity of an image. Thus, the intensities of a single sample can be compared without requiring spectral information to be obtained for all of k-space for a particular subject or patient.

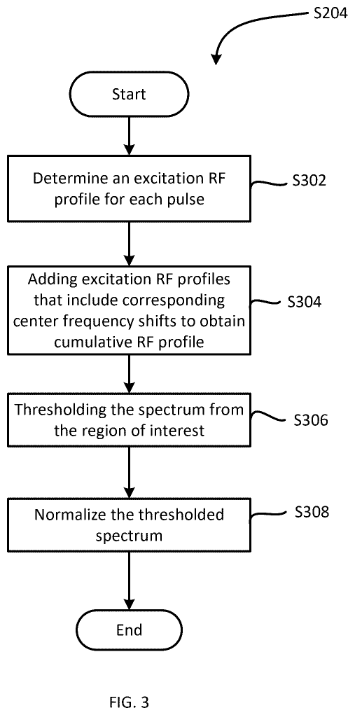

At S204 the at least one processor 30 may process the spectral information to output a spectrum for the region of interest. In at least one example embodiment, the spectrum for the region of interest may be related to off-resonances being present based on, for example, presence of a metallic implant. Processing the spectral information may correct and/or compensate for an impact of an RF spectral profile from a metallic implant, for example. Additional details of the processing of the spectral information are described below with reference to FIG. 3.

At S206, the at least one processor 30 may determine the imaging approach based on the spectrum for the ROI. The imaging approach may include optimized scan protocols determined from the spectrum. These optimized scan protocols and the imaging approach may compensate for any off-resonance due to metallic implants to ensure optimal imaging of the ROI. For example, the In at least one example embodiment an imaging approach may be selected from 2D multi-spectral imaging methods such as Slice Encoding for Metal Artifact Correction (SEMAC), 3D multi-spectral imaging methods such as Multi-Acquisition Variable-Resonance Image Combination (MAVRIC), and 2D-3D composite methods such as MAVRIC SL.

In at least one example embodiment, an imaging approach may be determined by a user or operator based on his or her observation of the spectrum of the ROI or based on a histogram of the spectrum of the ROI. The spectrum may be analyzed to determine a field inhomogeneity. An imaging approach may be determined based on the level of inhomogeneity that is observed in the spectra.

In at least one example embodiment, an imaging approach may be determined by comparing the spectrum with other spectra. For example, the at least one memory 25 may include or the at least one processor 30 may be configured to obtain typical spectra for various implants and various body parts. The spectrum obtained for the ROI may be compared to the typical spectra to determine a similar spectrum which may include an optimal imaging approach. In at least one example embodiment, deep learning approaches or methods and/or machine learning algorithms such as a neural networks may be employed to perform a non-linear comparison of the spectrum to the typical spectra. The deep learning or machine learning algorithms may be configured to determine an amount of spectral inhomogeneity and/or identify spectra of low, medium, and/or high inhomogeneity. This may enable a most similar spectrum of the typical spectra to be obtained to use as a guide to determine the imaging approach for the ROI.

In at least one example embodiment, the typical spectra may include spectra from different groups such as spectra from phantoms and/or humans and from particular regions of spectra of a human such as a hip region, shoulder region, knee region, wrist region, etc. The groups are not limited herein and may include additional or fewer groups in example embodiments. Thus, if a level of inhomogeneity of spectra coming from the hip region is being analyzed, it could be compared to spectra from a database that includes spectra from hip regions of various patient. Saved spectra for each group may include spectra for regions without an implant, with a low inhomogeneity implant (ceramic), a medium inhomogeneity implant (titanium), and/or a high inhomogeneity implant (cobalt chromium). Additionally, each group may include data from patients or subjects with different weights, heights, and gender. Thus, when comparing an obtained spectra to the stored spectra, data from the stored spectra may be sorted based one or more of weight, height, and/or gender prior to determining similar spectra. In at least one example embodiment, deep learning and/or machine learning algorithms or methods may be used to perform the comparison between a spectrum and stored spectra as described above. The deep learning or machine learning algorithms may be configured to identify a similar spectrum which may identify a spectrum as being similar to one of the groups of stored spectra. The deep learning or machine learning algorithms may additionally be configured to determine an inhomogeneity of a spectrum by comparing the spectrum to the stored spectra as described above.

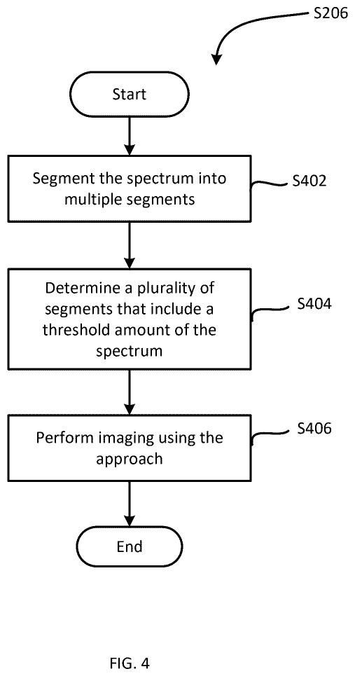

In at least one example embodiment, an imaging approach may be determined via a parametrizing method. Additional details of the determining of the imaging approach via the parametrizing method are described below with reference to FIG. 4.

FIG. 3 is a flow chart illustrating additional details of the step S204 of FIG. 2. At S302, an excitation RF profile is determined for each pulse of the plurality of RF pulses. The excitation RF profile for each pulse of the plurality of RF pulses is generally known. For example, the excitation RF profile may be defined and may be an input provided to the system. When determining the excitation RF profile, the at least one processor 30 may obtain information related to the excitation RF profile from the at least one memory 25 or may otherwise obtain the information related to the excitation RF profile to process the spectral information of the ROI.

At S304, the at least one processor 30 may add RF profiles for all excitations with corresponding center frequency shifts to obtain a cumulative RF profile. In particular, each excitation RF profile may be Gaussian rather than rectangular. Thus, for a given center frequency, frequencies around the center frequency are also excited. Thus, different frequencies will be applied multiple times and may be added to obtain the cumulative RF profile. From the cumulative RF profile, a range of frequencies may be selected. In at least one example embodiment, a range of frequencies that include more than a threshold level of excitation based on the cumulative RF profile may be selected. In at least one example embodiment, the threshold level may be 50% of the excitation. However, example embodiments are not limited herein. Selecting a threshold level of excitation may result in a range of frequencies that may be considered reliable to use for analyzing and comparing spectra for a ROI. The cumulative spectrum, with the selected range of frequencies, may be further analyzed to process the spectral information as described in further detail below.

At S306, the at least one processor 30 may threshold the spectrum of the ROI. In at least one example embodiment, the spectrum may be thresholded by removing spectral content below a threshold level. In at least one example embodiment, correcting the spectrum of the ROI may include selecting a range of frequencies from the cumulative spectrum described above. Thus, further spectral content may be removed, resulting in a smaller range of frequencies from the cumulative spectrum determined at S304. The spectrum for the ROI after the thresholding may be considered a thresholded spectrum in at least one example embodiment. The thresholded spectrum may have regions with noise removed and may also be considered a noise-corrected spectrum.

At S308, the at least one processor 30 may normalize the thresholded spectrum. The thresholded spectrum may be normalized by dividing the thresholded spectrum with the cumulative RF profile. The excitation RF profile provides information about a percentage of the ROI that was excited at a particular frequency. For example, if at a frequency of 500 Hz, an intensity of the spectra was measured as 100 and only 50% of the ROI was excited, then the normalized value for the spectrum at 500 Hz may be 100 divided by 0.5 which is 200. The thresholded spectrum may be normalized for each frequency based on the excitation RF profile to return a normalized spectrum. In at least one example embodiment thresholding of the spectrum may be optional and thus the spectrum from S304 may be normalized at S308.

The analysis performed on the spectrum may enable determination of present off-resonances that may be a result of an implant such as a metallic implant. The analysis may also enable an inference to be made about an orientation of the off-resonance that is present based on the implant. This analysis may enable a decision to be made for an imaging method as described above and in further detail below.

FIG. 4 is a flow chart illustrating additional details determining an imaging approach via a parametrizing method of the step S206 of FIG. 2.

At S402, the at least one processor 30 may segment the normalized spectrum into multiple segments. The normalized spectrum may be segmented to provide a spectrum with only a few segments to be analyzed. For example, the spectrum may be segmented such that each segment corresponds to a frequency range of 1000 Hz. In at least one example embodiment, a bandwidth of each segment may be equal to a bandwidth of an excitation pulse to be used when imaging the ROI. In at least one example embodiment, the at least one processor 30 may determine a percentage value histogram from the spectrum for each of the one or more segments. Segmenting the spectrum may provide high level view of the spectrum which may show where inhomogeneity of the spectrum is centered. This may enable faster categorization of inhomogeneities which may result in easier and faster processing of the spectrum to determine an imaging approach as described in further detail below.

At S404, the at least one processor 30 may determine a first plurality of segments of the multiple segments that include a threshold amount of the spectrum. In at least one example embodiment, the first plurality of segments of the spectrum may be analyzed to determine the field inhomogeneity. When there is low inhomogeneity which may indicate that no metal is present in the patient, a field inhomogeneity may be between about −1500 Hz and 1500 Hz. A medium inhomogeneity may indicate that a metal such as titanium is present and may have a field inhomogeneity of between about −1500 Hz to −5000 Hz or 1500 Hz to 5000 Hz. A high inhomogeneity may indicate that a metal such as cobalt chromium is present and may have a field inhomogeneity of less than about −5000 Hz or greater than about 5000 Hz. A low inhomogeneity may correspond to a first inhomogeneity level, a medium inhomogeneity may correspond to a second inhomogeneity level, and a high inhomogeneity may correspond to a third inhomogeneity level in at least one example embodiment. A normal imaging approach may be used for a low field inhomogeneity. Normal imaging approaches include gradient-echo or spin-echo based sequences with parameters that are used for subjects without metal implants. High bandwidth imaging methods may be used for spectra with a medium inhomogeneity. In particular, imaging approaches such as gradient-echo or spin-echo based sequences may be modified to be performed with higher bandwidth parameters for spectra with medium inhomogeneity. SEMAC methods or other multi-spectral imaging techniques may be used for spectra with high inhomogeneity, in at least one example embodiment. SEMAC methods or other multi-spectral imaging techniques may be used to complement and/or replace the normal imaging approaches described above.

While described herein as a low, medium, and high inhomogeneity, the spectrum may be divided into any number of thresholds or segments that may be more or less granular. For example, there may be two, four, five or more frequency thresholds that may be defined as corresponding to different levels of inhomogeneity.

In at least one example embodiment, determining the imaging approach may additionally include performing the determined imaging approach. Thus, at S406, the at least one processor 30 may communicate with the acquisition device 20 of the system 10 to cause the system 10 to perform imaging using the determined imaging approach. In at least one example embodiment, the imaging may be performed by exciting the region of interest one or more times with the excitation pulse corresponding to the first plurality of segments.

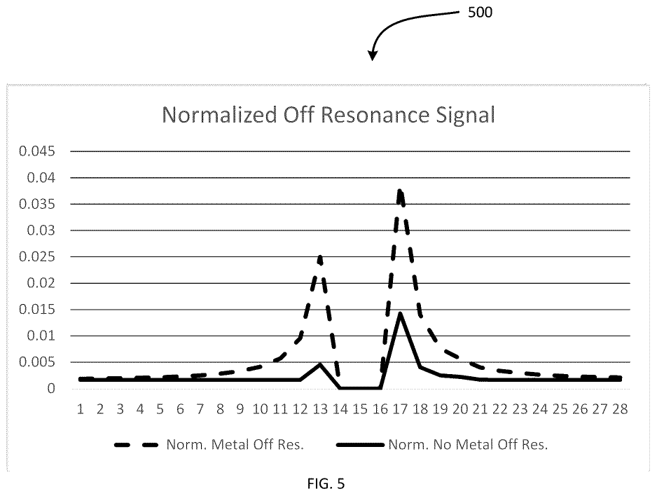

FIG. 5 is a graph 500 illustrating a comparison between an off resonance signal from an MR scan with metal present and an off resonance signal from an MR scan where no metal is present. The data for the graph 500 was obtained using a 1.5 T MR imaging scanner and the metal for the MR scan with metal present is cobalt chromium. The x-axis of the graph 500 represents bins that the signals have been segmented into and the y-axis of the graph 500 represents the normalized off-resonance signal. The signal from the bins 14, 15, and 16 of the graph 500 has been removed for being on-resonance so that only off-resonance signals are present.

In at least one example embodiment, bin 15 may correspond to a signal of 0 Hz, bin 14 may correspond to a signal of −1000 Hz, and bin 16 may correspond to a signal of 1000 Hz. A signal of 0 Hz, for example, describes a center frequency of a pulse. The pulse may have a bandwidth that may extend in both a positive and negative direction from the center frequency. For example, the bandwidth of the 0 Hz pulse may extend from approximately −1000 Hz to 1000 Hz. Each bin of the plurality of bins of the graph 500 may be separated from an adjacent bin by 1000 Hz in at least one example embodiment. Here, the 0 Hz signal is on-resonance and the 1000 Hz and −1000 Hz signals may overlap with the 0 Hz signal due to the Gaussian profile of the signals. Thus, each of bins 14, 15, and 16 may be considered on-resonance and the normalized signals from these bins may be excluded from the graph 500.

In at least one example embodiment, generating a graph such as the graph 500 may enable MR scans with and without metal to be distinguished from one another. As shown in the graph 500, in bin 13, the metal MR scan has a normalized off-resonance signal of approximately 0.025 which the no-metal MR scan has a normalized off-resonance signal of approximately 0.0046. For bin 15, the metal MR scan has a normalized off-resonance signal of approximately 0.039 which the no-metal MR scan has a normalized off-resonance signal of approximately 0.014. The differences between these off-resonance signals illustrate the difference between an MR scan with metal present and with no metal present. In at least one example embodiment, a normalized signal from an MR scan may be compared to data in a database to distinguish an acquisition with metal from an acquisition without metal and also to distinguish acquisitions with different types of meal. Based on the differences between the off-resonance signals between the metal scan and the no-metal scan, an imaging approach may be determined as described above.

The above-described systems and methods provide guidance on an optimal scan to use to image a patient who has a metallic implant. In particular, the systems and methods described herein provide a prescan method that is quick and may provide objective guidance for what scan strategy to use for a patient with a metallic implant based on an observed field inhomogeneity for the patient. The prescan method may be completed in a matter of seconds which may provide important information to an operator without adding a significant amount of time to an imaging method.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

### NON-LIMITING ILLUSTRATIVE EMBODIMENTS

The following is a list of non-limiting illustrative embodiments disclosed herein:

Illustrative embodiment 1 includes a system for determining an imaging approach, the system comprising: at least one memory configured to store instructions; and at least one processor configured to execute the instructions to cause the system to apply a plurality of radio frequency (RF) pulses to a region of interest to acquire spectral information, each pulse having a different center frequency, process the spectral information to output a spectrum for the region of interest, and determine the imaging approach based on the spectrum for the region of interest.

Illustrative embodiment 2 includes the system of illustrative embodiment 1, wherein the different center frequencies of the RF pulses are between about −10 kHz to 10 kHz.

Illustrative embodiment 3 includes the system of illustrative embodiment 1 or 2, wherein processing the spectral information includes determining a cumulative RF profile by determining an excitation RF profile for each pulse of the plurality of RF pulses; and adding excitation RF profiles that include corresponding center frequency shifts to obtain the cumulative RF profile.

Illustrative embodiment 4 includes the system of illustrative embodiment 3, wherein the at least one processor is further configured to cause the system to theshold the spectrum from the region of interest by removing spectral content below a threshold level to obtain a thresholded spectrum and divide the thresholded spectrum with the cumulative RF profile to obtain a noramlized spectrum.

Illustrative embodiment 5 includes the system of illustrative embodiment 4, wherein the at least one processor is further configured to cause the system to segment the spectrum into one or more segments.

Illustrative embodiment 6 includes the system of any one of illustrative embodiments 4, or 5, wherein the imaging approach is determined by comparing the normalized spectrum for the region of interest to one or more thresholds.

Illustrative embodiment 7 includes the system of illustrative embodiment 6, wherein a level of inhomogeneity of the spectrum is determined from the one or more thresholds.

Illustrative embodiment 8 includes the system of any one of illustrative embodiments 6 or 7, wherein the one or more thresholds include a first threshold corresponding to a first level of inhomogeneity, a second threshold corresponding to a second level of inhomogeneity, a third threshold corresponding to a third level of inhomogeneity, a first imaging approach corresponds to the first level of inhomogeneity, a second imaging approach corresponds to the second level of inhomogeneity, and a third imaging approach corresponds to the third level of inhomogeneity.

Illustrative embodiment 9 includes the system of any one of illustrative embodiments 6, 7, or 8, wherein a deep learning approach is used to compare the spectrum for the region of interest to the one or more thresholds to determine the imaging approach.

Illustrative embodiment 10 includes the system of any one of illustrative embodiments 5, 6, 7, 8, or 9, wherein the at least one processor is further configured to cause the system to determine a percentage value histogram from the normalized spectrum for each of the one or more segments.

Illustrative embodiment 11 includes the system of any one of illustrative embodiments 5, 6, 7, 8, 9, or 10, wherein the at least one processor is further configured to cause the system to determine a first plurality of segments of the one or more segments that include a threshold amount of the normalized spectrum.

Illustrative embodiment 12 includes the system of illustrative embodiment 11, wherein the at least one processor is further configured to cause the system to perform imaging using the imaging approach by exciting the region of interest one or more times with an excitation pulse corresponding to the first plurality of segments.

Illustrative embodiment 13 includes the system of any one of illustrative embodiments 1, 2, 3, 4, 5, 6, 7, 8, 9, 10, 11, or 12, wherein the imaging approach is determined by comparing the spectrum to stored spectra.

Illustrative embodiment 14 includes a prescan method for determining an imaging approach, the method comprising: applying a plurality of radio frequency (RF) pulses to a region of interest to acquire spectral information, each pulse having a different center frequency, processing the spectral information to output a spectrum for the region of interest, and determining the imaging approach based on the spectrum for the region of interest.

Illustrative embodiment 15 includes the method of illustrative embodiment 14, wherein the processing the spectral information includes determining a cumulative RF profile by determining an excitation RF profile for each pulse of the plurality of RF pulses; adding excitation RF profiles that include corresponding center frequency shifts to obtain the cumulative RF profile; thresholding the spectrum from the region of interest by removing spectral content below a threshold level to obtain a thresholded spectrum; and dividing the thresholded spectrum with the cumulative RF profile to obtain a normalized spectrum.

Illustrative embodiment 16 includes the method of illustrative embodiment 15, wherein the imaging approach is determined by comparing the normalized spectrum for the region of interest to one or more thresholds.

Illustrative embodiment 17 includes the method of illustrative embodiment 16, wherein a level of inhomogeneity of the spectrum is determined from the one or more thresholds.

Illustrative embodiment 18 includes the method of any one of illustrative embodiments 16 or 17, wherein the one or more thresholds include a first threshold corresponding to a first level of inhomogeneity, a second threshold corresponding to a second level of inhomogeneity, a third threshold corresponding to a third level of inhomogeneity, a first imaging approach corresponds to the first level of inhomogeneity, a second imaging approach corresponds to the second level of inhomogeneity, and a third imaging approach corresponds to the third level of inhomogeneity.

Illustrative embodiment 19 includes the method of any one of illustrative embodiments 16, 17, or 18, wherein a deep learning approach is used to compare the spectrum for the region of interest to the one or more thresholds to determine the imaging approach.

Illustrative embodiment 20 includes the method of any one or illustrative embodiments 15, 16, 17, 18, or 19, further comprising: segmenting the normalized spectrum into one or more segments; determining a first plurality of segments of the one or more segments that include a threshold amount of the spectrum; and performing imaging using the imaging approach by exciting the region of interest one or more times with an excitation pulse corresponding to the first plurality of segments.

We claim:

1. A system for determining an imaging approach, the system comprising:
at least one memory configured to store instructions; and
at least one processor configured to execute the instructions to cause the system to
apply a plurality of radio frequency (RF) pulses to a region of interest to acquire spectral information, each pulse having a different center frequency,
process the spectral information to output a spectrum for the region of interest, and
determine the imaging approach based on the spectrum for the region of interest.

2. The system of claim 1, wherein the different center frequencies of the RF pulses are between about −10 kHz to 10 kHz.

3. The system of claim 1, wherein processing the spectral information includes determining a cumulative RF profile by
determining an excitation RF profile for each pulse of the plurality of RF pulses; and
adding excitation RF profiles that include corresponding center frequency shifts to obtain the cumulative RF profile.

4. The system of claim 3, wherein the at least one processor is further configured to cause the system to
threshold the spectrum from the region of interest by removing spectral content below a threshold level to obtain a thresholded spectrum; and
divide the thresholded spectrum with the cumulative RF profile to obtain a normalized spectrum.

5. The system of claim 4, wherein the at least one processor is further configured to cause the system to
segment the normalized spectrum into one or more segments.

6. The system of claim 4, wherein the imaging approach is determined by comparing the normalized spectrum for the region of interest to one or more thresholds.

7. The system of claim 6, wherein a level of inhomogeneity of the spectrum is determined from the one or more thresholds.

8. The system of claim 6, wherein the one or more thresholds include a first threshold corresponding to a first level of inhomogeneity, a second threshold corresponding to a second level of inhomogeneity, a third threshold corresponding to a third level of inhomogeneity, a first imaging approach corresponds to the first level of inhomogeneity, a second imaging approach corresponds to the second level of inhomogeneity, and a third imaging approach corresponds to the third level of inhomogeneity.

9. The system of claim 6, wherein a deep learning approach is used to compare the spectrum for the region of interest to the one or more thresholds to determine the imaging approach.

10. The system of claim 5, wherein the at least one processor is further configured to cause the system to
determine a percentage value histogram from the normalized spectrum for each of the one or more segments.

11. The system of claim 5, wherein the at least one processor is further configured to cause the system to
determine a first plurality of segments of the one or more segments that include a threshold amount of the normalized spectrum.

12. The system of claim 11, wherein the at least one processor is further configured to cause the system to
perform imaging using the imaging approach by exciting the region of interest one or more times with an excitation pulse corresponding to the first plurality of segments.

13. The system of claim 1, wherein the imaging approach is determined by comparing the spectrum to stored spectra.

14. A prescan method for determining an imaging approach, the method comprising:
applying a plurality of radio frequency (RF) pulses to a region of interest to acquire spectral information, each pulse having a different center frequency,
processing the spectral information to output a spectrum for the region of interest, and
determining the imaging approach based on the spectrum for the region of interest.

15. The method of claim 14, wherein the processing the spectral information includes determining a cumulative RF profile by
determining an excitation RF profile for each pulse of the plurality of RF pulses;
adding excitation RF profiles that include corresponding center frequency shifts to obtain the cumulative RF profile;
thresholding the spectrum from the region of interest by removing spectral content below a threshold level to obtain a thresholded spectrum; and
dividing the thresholded spectrum with the cumulative RF profile to obtain a normalized spectrum.

16. The method of claim 15, wherein the imaging approach is determined by comparing the normalized spectrum for the region of interest to one or more thresholds.

17. The method of claim 16, wherein a level of inhomogeneity of the spectrum is determined from the one or more thresholds.

18. The method of claim 16, wherein the one or more thresholds include a first threshold corresponding to a first level of inhomogeneity, a second threshold corresponding to a second level of inhomogeneity, a third threshold corresponding to a third level of inhomogeneity, a first imaging approach corresponds to the first level of inhomogeneity, a second imaging approach corresponds to the second level of inhomogeneity, and a third imaging approach corresponds to the third level of inhomogeneity.

19. The method of claim 16, wherein a deep learning approach is used to compare the spectrum for the region of interest to the one or more thresholds to determine the imaging approach.

20. The method of claim 15, further comprising:
segmenting the normalized spectrum into one or more segments;
determining a first plurality of segments of the one or more segments that include a threshold amount of the spectrum; and
performing imaging using the imaging approach by exciting the region of interest one or more times with an excitation pulse corresponding to the first plurality of segments.
